(19) United States
(12) Patent Application Publication
(10) Pub. No.: US 2007/0245588 A1
(43) Pub. Date: Oct. 25, 2007

(54) Cylindrical dryer having conduits for heating medium

(76) Inventors: Osvaldo Ricardo Haurie, Buenos Aires (AR); Richard Kenneth Haurie, Alexandria, VA (US)

Correspondence Address: Hoffman, Wasson & Gitler, P.C., Suite 522, 2461 South Clark Street, Arlington, VA, 22202, US

(21) Appl. No.: 11/785,614

(22) Filed: Apr. 19, 2007

Related U.S. Application Data
(60) Provisional application No. 60/793,657, filed on Apr. 21, 2006.

(51) Int. Cl. D06F 58/00; F26B 3/00

(52) U.S. Cl. 34/114; 34/122; 34/454

(57) ABSTRACT

A dryer uses conduits to carry a heating medium, such as steam, to heat the outer surface of the dryer. The volume of steam is successfully reduced to non-explosive levels and the shell need not be designed to prevent an explosion. Conduits may be formed through the shell itself or grooves may be formed on the inner surface of the shell, with the conduits retained within the grooves. Also, the conduits can be placed against the inside surface of the dryer and a material, such as zinc, can be filled in about the conduits. The material serves to both retain the conduits in place and thermally couple the conduits to the dryer to assure efficient heat transfer between the conduits and dryer. These modifications relieve the dryer from the Unfired Pressure Vessel classification to the classification of a piping assembly under ASA code regulations. This results in savings in operation safety, installation cost and operating costs due to the absence of costly inspections.

This application claims benefit of provisional application 60/793,657, filed Apr. 21, 2006.

### BACKGROUND OF THE INVENTION

Cylindrical dryers are used in the paper making process. Webs of paper are passed over heated cylindrical drums to remove moisture from the web. The large cylindrical dryers, often referred to as “Yankee Dryers,” must be continuously heated to maintain an elevated temperature during the paper making process.

One type of Yankee dryer has an inner and outer shell. The space created between the inner and outer shell is fed with a heating medium, such as steam under pressure, to heat the outer surface of the dryer. The dryers are commonly made out of cast iron. A double shelled cast iron dryer is difficult to cast, costly and extremely heavy. Double shelled dryers were very rare and the idea was abandoned early.

Another type of Yankee dryer has a closed cylinder with pressurized steam fed into the cylinder. The pressurized steam raises the possibility of catastrophic explosion when the cylinder fails under the pressure. One possible solution to explosion risks in a pressurized cylinder type Yankee dryer is to fill the volume within the cylinder with spheres. Spheres occupy space within the cylinder and reduces the amount of pressurized steam. This reduced amount of pressurized steam lowers the risk of explosions. Problems with this approach include the need to use a non-compressible material for the spheres, increasing the weight of the dryer. Also, with spheres of equal size the total volume cannot be reduced more than approximately two thirds. This reduction is not enough for the purposes of reducing the amount of steam.

### SUMMARY OF THE INVENTION

A dryer uses conduits to carry a heating medium, such as steam, to heat the outer surface of the dryer. The volume of steam is successfully reduced to non-explosive levels and the shell need not be designed to prevent an explosion. Conduits may be formed through the shell itself or grooves may be formed on the inner surface of the shell, with the conduits retained within the grooves. Also, the conduits can be placed against the inside surface of the dryer and a material, such as zinc, can be filled in about the conduits. The material serves to both retain the conduits in place and thermally couple the conduits to the dryer to assure efficient heat transfer between the conduits and dryer. These modifications relieve the dryer from the Unfired Pressure Vessel classification to the classification of a piping assembly under ASA code regulations. This results in savings in operation safety, installation cost and operating costs due to the absence of costly inspections.

### BRIEF DESCRIPTION OF THE DRAWINGS

FIG. 1 shows a perspective view of shells having conduits formed within the shell;

FIG. 2 shows an end perspective view of a shell having conduits on the inner surface;

FIG. 3 shows a flow path for the conduits;

FIGS. 4a and 4b shows end and side views of an alternative arrangement for providing steam to conduits;

FIG. 5 shows a side cross-sectional view of coiled conduits on the inner surface of a shell;

FIG. 6 shows a flow diagram for steam through the loop arrangement;

FIG. 7 is a perspective view of the flow path of steam through loops;

FIG. 8 is a side cross-sectional view of an alternative arrangement for providing steam through a heat transfer tube;

FIG. 9 is a perspective view of the arrangement of FIG. 9; and

FIG. 10 is a cross sectional view of a shell having a holding plate.

### DETAILED DESCRIPTION OF THE INVENTION

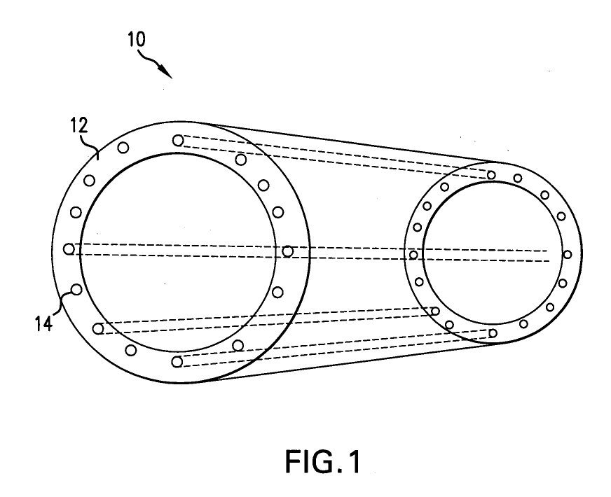

FIG. 1 shows a dryer 10 formed by a single shell 12 with a series of conduits 14 running along the length of the dryer. The dryer 10 is made of any suitable material, such as cast iron or stainless steel. These conduits 14 continuously carry a heating medium, such as steam, to heat the outside surface of the dryer, over which the paper web passes. By forming conduits within the shell, heat transfer occurs about the entire perimeter of the conduit, affording a maximum heat transfer surface. By way of example, a shell having a ¾ inch thickness can have conduits ¼ inch in diameter. The number of conduits is limited to maintain the shell's integrity.

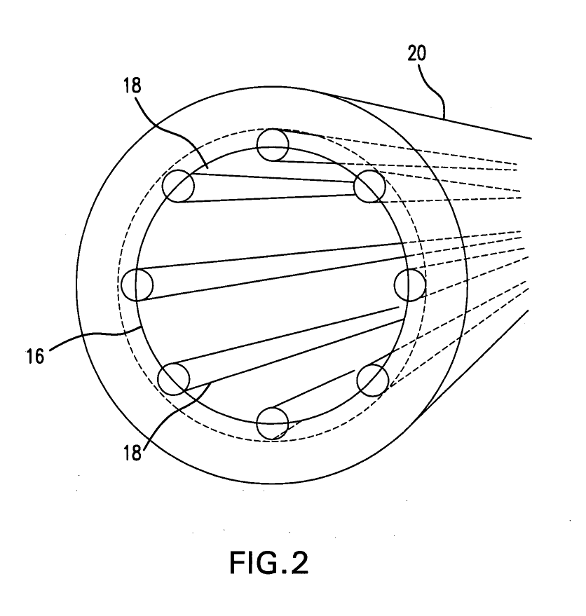

An alternative arrangement shown in FIG. 2 forms grooves within the inner surface 16 of the shell and places conduits 18 within the groove. The grooves can have a depth equal to half the diameter of the conduits. A conduit inserted to a depth equal to its radius and placed side-to-side offers an increase of 54% in heat transfer surface of the inside surface 16 of the dryer. Conduits are often spaced from one another, not place side-to-side, reducing the 54% increase in surface area of the inner surface but enough conduits are used to effectively heat the outside surface 20 of the dryer.

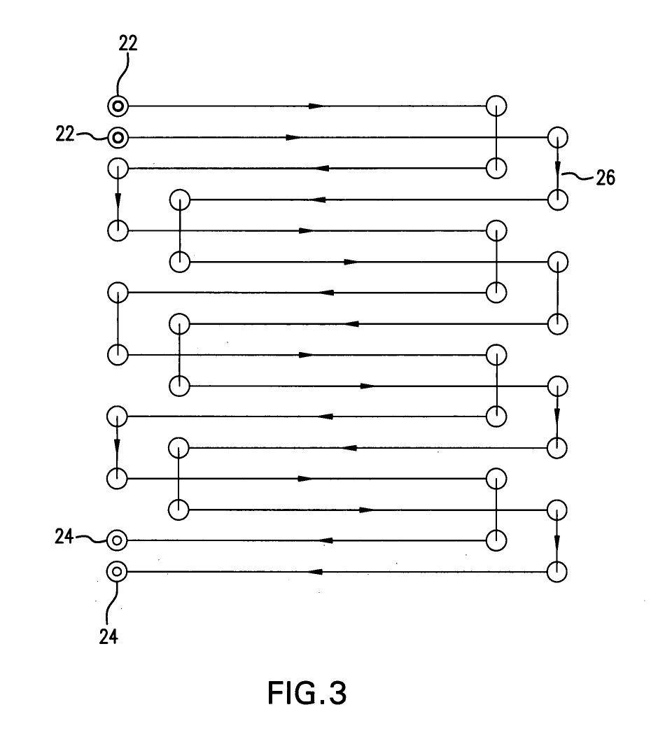

FIG. 3 shows a schematic diagram of the heating medium flow through the conduits. In this view, the left and right side of the dryer are represented on the left and right sides of the diagram. The layout is as if the dryer has been split along its length and been flattened, so that the inner surface of the dryer is visible. In this arrangement, two inlets 22 and two outlets 24 are used to establish two parallel flows of heating medium. The heating medium enters through the inlet, travels the entire length of the dryer through the conduit and then connects to another conduit through a riser 26 and flows back to the left side. This process is repeated as the heating medium moves back and forth across the length of the dryer until it reaches the outlet 24. While two parallel flows are shown, it is understood that any number of inlets and outlets may be used and the outlets may be on the end opposite of the inlet.

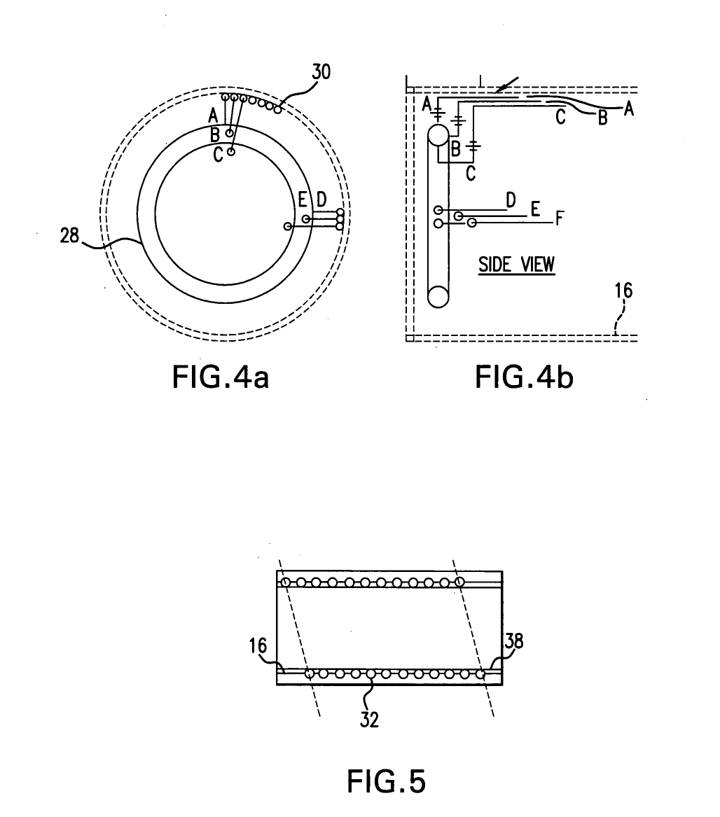

FIG. 4a shows an alternative arrangement, providing each conduit with an inlet and outlet for steam. This arrangement can be used when using iron pipes and offers easier assembly and maintenance. A circular header 28 providing steam has a series of conduits 30 attached thereto. As seen in FIG. 4b, the conduits 30 are attached to the top, side and bottom surfaces of the circular header 28 allowing a greater number of ports without sacrificing the structural integrity of the header. Each conduit 30 receives heating medium from the header and connects to a similar header at the opposite end of the dryer as an outlet.

FIG. 5 shows a view of a dryer having a helically arranged tube 32 extending the length of the dryer. Again, the tube may be inserted in grooves having a depth equal to the radius of the tube. One advantage of the helical arranged coils is that, upon heating, the helix expands, further securing the tubes within the groove. Conduits placed against the inner surface 16 the dryer may be embedded in a filler material such as zinc to create a new inner surface 38. The conduits can be completely embedded but this is not necessary. The material thermally and mechanically couples the conduit to the dryer. This process requires no machining of the dryer and ensures a high rate of thermal transfer from the steam to the outside surface 40 of the dryer. This process can be retrofitted to existing dryers, regardless of the shell thickness and used with axially extending tubes, as well as a helically extending tube.

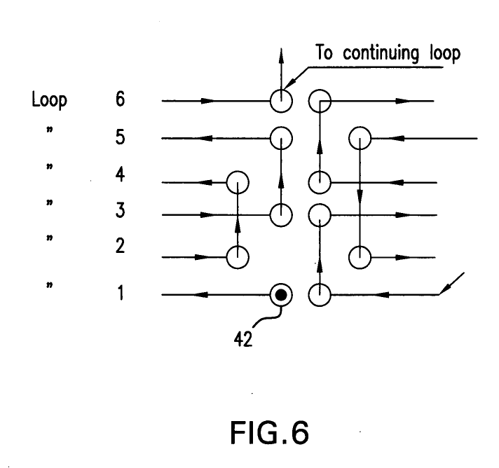

FIG. 6 shows the movement of steam, or other heating medium, through loops. Starting with the steam supply 42, the steam extends through the first loop, connects to the third loop. After completion of the three loops, steam is transferred to the fifth loop. As seen in the drawings, when complete with the fifth loop, steam is returned to the second loop through a conduit. Upon completion of the second loop, steam travels to the fourth loop and, finally, to the sixth loop.

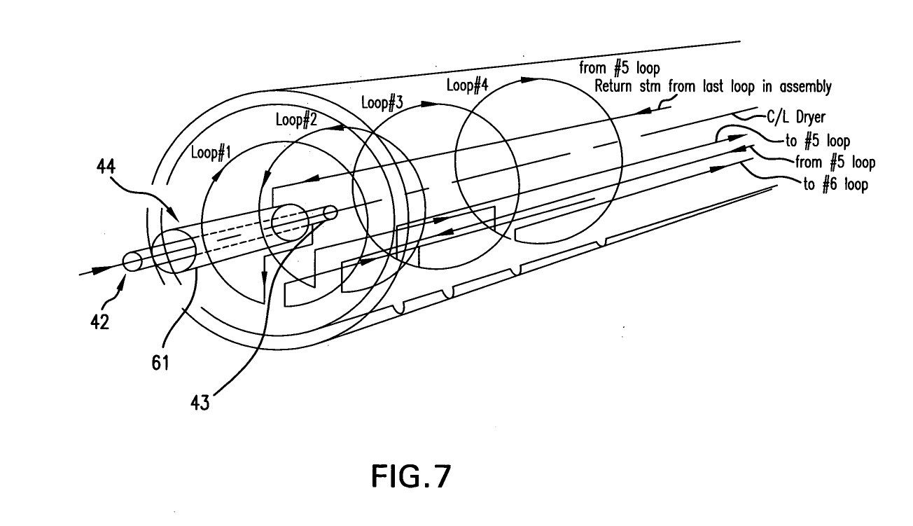

FIG. 7 shows this path in a three-dimensional perspective view with loops one through four shown for purposes of clarity. Also seen in FIG. 7 is the concentric steam supply 42 and outlet 44. The inner tube 43, having a length greater than the outer tube 61, carries the inlet steam with the outer, larger and shorter tube, serving as the outlet for exhaust steam.

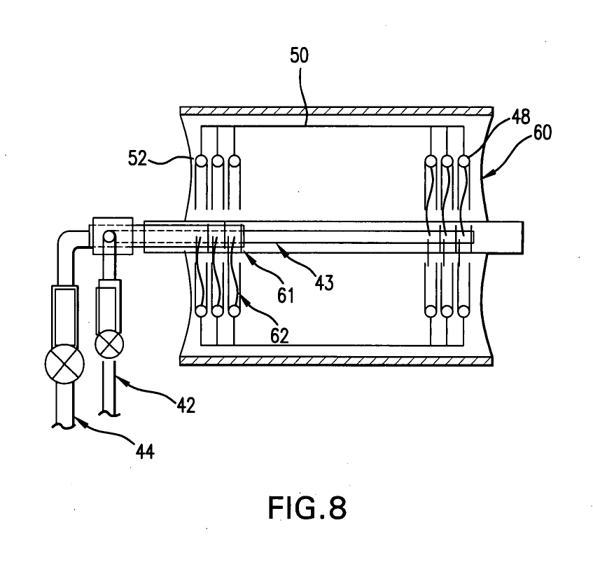

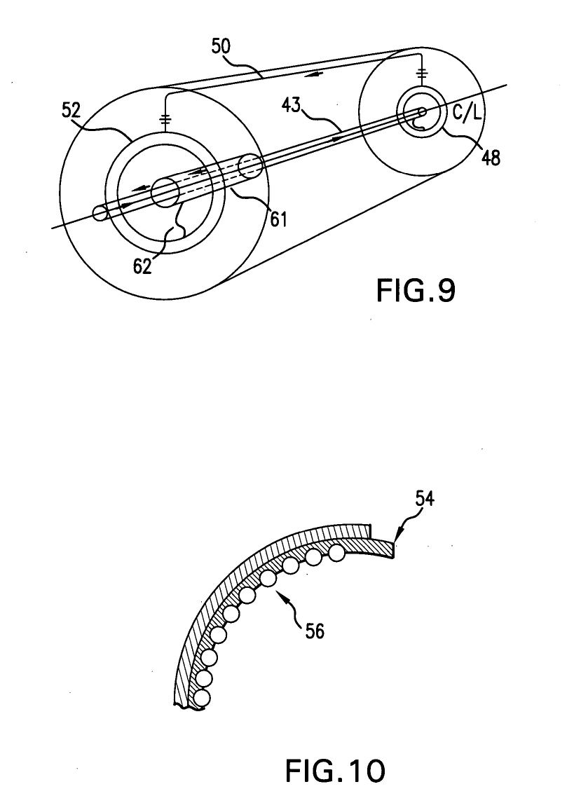

FIG. 8 shows an arrangement using the concentric steam supply and return. In this arrangement, the steam supply stem 43 extends the entire length of the dryer and feeds a series of floating ring headers 48 by steam hoses 60. Heat transfer tubes 50 receive the steam from the headers and are connected to exhaust return steam ring headers 52 which, in turn, connect to the outer steam return 61 by steam hoses 62. The arrangement is also clearly seen in FIG. 9, which uses a single steam supply 46 and exhaust return steam ring headers 52.

FIG. 10 is a cross section view of a shell using a holding plate 54 to which conduits 56 are attached. To facilitate assembly of new dryers or the retrofitting of existing dryers, the conduits are first attached to the holding plate 54 and then the holding plate to attached to the inner surface of the dryer. An advantage of this arrangement is the ability to use several holding plates to cover the interior surface of the dryer.

The use of conduits on the inner surface of a dryer shell allows higher pressure steam to be used. Existing dryers can be retrofit with grooves and conduits at little cost. The system has a longer life span and less down time than prior yankee dryers leading to great savings for the manufacturing plants.

While the invention has been described with reference to preferred embodiments, variations and modifications would be apparent to one of ordinary skill in the art. The invention encompasses such variations and modifications.

What is claimed is:

1. A yankee dryer, comprising:
a cylindrical shell having an outer surface and an inner surface,
at least one conduit in said dryer, and
a source of heating medium connected to said at least one conduit.

2. The dryer of claim 1, further comprising a plurality of conduits, the plurality of conduits extending between the shell inner and outer surface.

3. The dryer of claim 1, wherein said at least one conduit comprises a helically extending conduit, said helically extending conduit contacting the inner surface of the shell.

4. The dryer of claim 3, wherein the helically extending conduit rests within a groove in the shell inner surface.

5. The dryer of claim 3, further comprising:
a filler material about the helically extending conduit.

6. The dryer of claim 1, further comprising:
a supply steam ring header within the shell,
an exhaust steam ring header within the shell, and
a plurality of conduits extending between the supply header and the exhaust header.

7. The dryer of claim 1, further comprising:
a holding plate,
the at least one conduit attached to the holding plate,
the holding plate attached to the shell inner surface.

8. The dryer of claim 1, wherein the heating medium is steam.

9. The dryer of claim 1, further comprising:
at least one inlet,
at least one outlet,
a plurality of conduits extending along the inner surface of the dryer,
one conduit connected to the inlet,
one conduit connected to the outlet,
each conduit connected to another conduit by a riser.
